(19) United States
(12) Patent Application Publication
(10) Pub. No.: US 2022/0289443 A1
(43) Pub. Date: Sep. 15, 2022

(54) TIE POST FOR REUSABLE TWIST TIE AND TWIST TIE HAVING TIE POST INTEGRALLY FORMED THEREON

(71) Applicant: Robert J. BASCHNAGEL, Garden City, NY (US)

(72) Inventor: Robert J. BASCHNAGEL, Garden City, NY (US)

(21) Appl. No.: 17/330,588

(22) Filed: May 26, 2021

Related U.S. Application Data
(63) Continuation-in-part of application No. 17/197,588, filed on Mar. 10, 2021.

(51) Int. Cl. B65D 63/12

(52) U.S. Cl. CPC B65D 63/12; B65D 2563/107

(57) ABSTRACT

A reusable twist tie including: an elongated core formed of a malleable material; an outer cover for covering the core, the outer cover being formed of an elastomer; an end cap formed of a material having a greater hardness than the outer cover, the end cap being fixed at a first end of the outer cover; and a tie post. The tie post including: a first end fixed to a second end of the outer cover; a post extending in a longitudinal direction from the first end configured for wrapping the outer cover around the post; and a second end having a surface for preventing the wrapped outer cover from moving in the longitudinal direction off of the post.

### CROSS REFERENCE TO RELATED APPLICATION

This application is a continuation in part of U.S. application Ser. No. 17/197,588 filed on Mar. 10, 2021, the entire contents of which is incorporated herein by reference.

### BACKGROUND

### Field

The present disclosure relates generally to reusable twist ties (also known as gear ties), and, in particular, relates to a tie post for reusable twist ties and a reusable twist tie having a tie post integrally formed thereon.

### Prior Art

Plastic tie wraps are used in many electrical applications as well as non-electrical applications such as keeping things organized and secure. However, such plastic tie wraps can only be used once and must be cut off when no longer desired. In view of such background, reusable twist ties (also known in gear ties) have been developed. Such reusable twist ties generally have a malleable metal internal wire or wires with an outer rubber covering. Such twist ties can come in various lengths and diameters and generally have a small hard plastic knob on each end.

In use, the reusable twist ties tie around another object or objects and ties upon itself for securing the object/objects. However, the degree to which such twist tie can secure the object/objects is limited due to being tied upon itself both from a structural standpoint and because a user usually cannot tie the twist tie upon itself in the most efficient manner.

### SUMMARY

Accordingly, a tie post is provided for use with a reusable twist tie. The tie post comprising: a first end being configured for removable attachment to the reusable twist tie; a post extending in a longitudinal direction from the first end configured for wrapping an elongated portion of the reusable twist tie around the post; and a second end having a surface for preventing the wrapped elongated portion of the reusable twist tie from moving in the longitudinal direction off of the post.

The first end can comprises a first portion integrally formed with the post and a second portion removably attached to the first portion. The first portion can have one of a concavity and a projection and the second portion can have the other of the concavity and the projection where the second portion is configured to elastically deform such that the projection mates with the concavity.

The first end can have a c-shape in cross section, where the first portion can be configured to elastically deform to fit over the elongated portion of the reusable twist tie.

The first portion and the second portion can have a clamshell configuration to sandwich the elongated portion of the reusable twist tie therebetween.

The post can be circular in cross section. A length of the post in the longitudinal direction can be at least twice an outer diameter of the elongated portion of the reusable twist tie.

The surface of the second end can be a lower surface of a cylindrical disk at the second end. Half a difference between an outer diameter of the post and an outer diameter of the cylindrical disk can be equal to or greater than an outer diameter of the elongated portion of the reusable twist tie.

The second end can include an other surface having an indicia provided thereon. The other surface can be removable from the second end.

The second end can comprise first and second cleats extending from the post, a free end of the first and second cleats can extend in opposing directions.

The surface of the second end can be oval.

Also provided is a reusable twist tie comprising: an elongated core formed of a malleable material; an outer cover for covering the core, the outer cover being formed of an elastomer; first and second end caps formed of a material having a greater hardness than the outer cover, the first and second end caps being disposed at corresponding ends of the outer cover; wherein one or more of the first and second end caps comprises a tie post, the tie post comprising; a first end integrally formed with one or more of the first and second end caps; a post extending in a longitudinal direction from the first end configured for wrapping the outer cover around the post; and a second end having a surface for preventing the wrapped outer cover from moving in the longitudinal direction off of the post.

The post can be circular in cross section. A length of the post in the longitudinal direction can be at least twice an outer diameter of the outer cover.

The surface of the second end can be a lower surface of a cylindrical disk at the second end. Half a difference between an outer diameter of the post and an outer diameter of the cylindrical disk can be equal to or greater than an outer diameter of the elongated portion of the reusable twist tie.

The second end can include an other surface having an indicia provided thereon. The other surface can be removable from the second end.

### BRIEF DESCRIPTION OF THE DRAWINGS

FIG. 1 illustrates a first embodiment of a tie post for use with a reusable twist tie.

FIG. 2 illustrates the tie post of FIG. 1 in an unassembled state.

FIG. 3 illustrates the tie post of FIG. 2 in the unassembled state relative to a reusable twist tie.

FIG. 4 illustrates the tie post of FIG. 3 in an assembled state to the reusable twist tie.

FIGS. 5 and 6 illustrate another end of the reusable twist tie being secured to the tie post of FIG. 4.

FIG. 7 illustrates a variation of the tie post of the first embodiment of FIG. 1.

FIG. 8 illustrates a second embodiment of a tie post being integrally formed on an end of the reusable twist tie.

FIG. 9 illustrates a third embodiment of a tie post having a boat cleat configuration.

FIG. 10 illustrates the tie post of FIG. 9 having a reusable twist tie secured thereto.

FIG. 11 illustrates a fourth embodiment of tie post for use with a reusable twist tie.

FIGS. 12 and 13 illustrate the tie post of FIG. 11 having a clam-shell type attachment to the reusable tie post.

FIG. 14 illustrates a variation of tie post having an indicia formed on a surface thereof.

FIG. 15 illustrates the tie post of FIG. 14 where the indicia is removable and replaceable.

In FIGS. 14 and 15, the indicia shown is a registered Trademark of Sterling Mets, L.P.

FIG. 16 illustrates a perspective view of another embodiment of twist tie in which the elongated portion and tie post are extended in a same longitudinal axis.

FIG. 17 illustrates the twist tie of FIG. 16 in which the tie post is bent to deviate from the longitudinal axis.

FIG. 18 illustrates the twist tie of FIG. 17 in which a portion of the elongated body is wrapped around the tie post.

FIG. 19 shows a partial sectional view of the elongated body of the twist tie in FIGS. 16-18.

### DETAILED DESCRIPTION

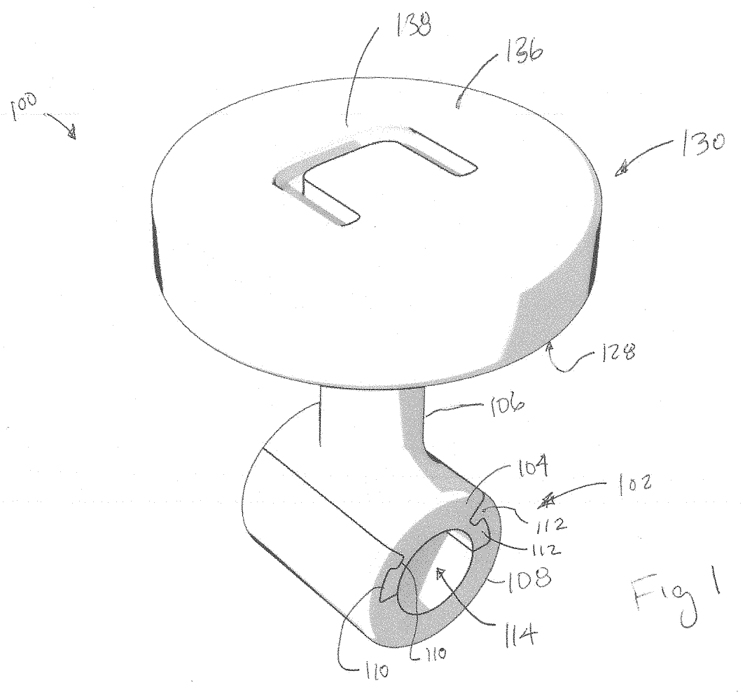

Referring now to FIGS. 1-6, there is shown a tie post, generally referred to by reference numeral 100, for use with a reusable twist tie. As known in the art, the reusable twist tie 120 includes an elongated portion 118 having an elongated core formed of a malleable material, such as a metallic wire and an outer cover for covering the core, the outer cover is generally formed of an elastomer, such as rubber. The reusable twist tie also has first and second end caps 122 disposed at corresponding ends of the outer cover. The first and second end caps being generally formed of a material having a greater hardness than the outer cover, such as a hard plastic.

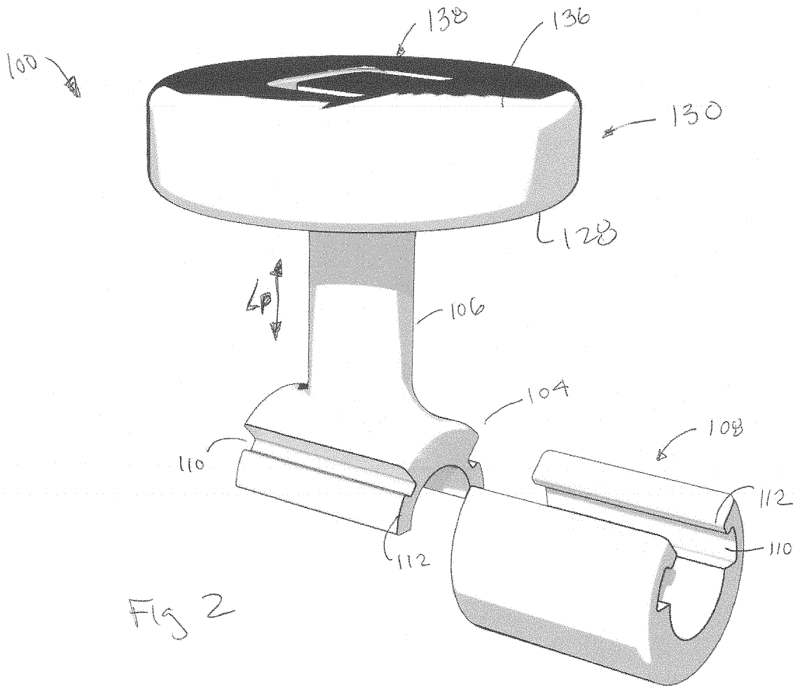

The tie post can be formed, such as by injection molding from plastic or other resilient materials. A first end 102 of the tie post 100 is configured for removable attachment to the reusable twist tie. In a first configuration of the first end shown in FIG. 1, a first portion 104 is integrally formed with a post 106 and a second portion 108 is removably attached to the first portion 104, as shown in FIGS. 1 and 2. The first and second portions 104, 108 can have a concavity 110 and/or a mating projection 112 that securely fit together such as by a sliding contact as shown in FIG. 2.

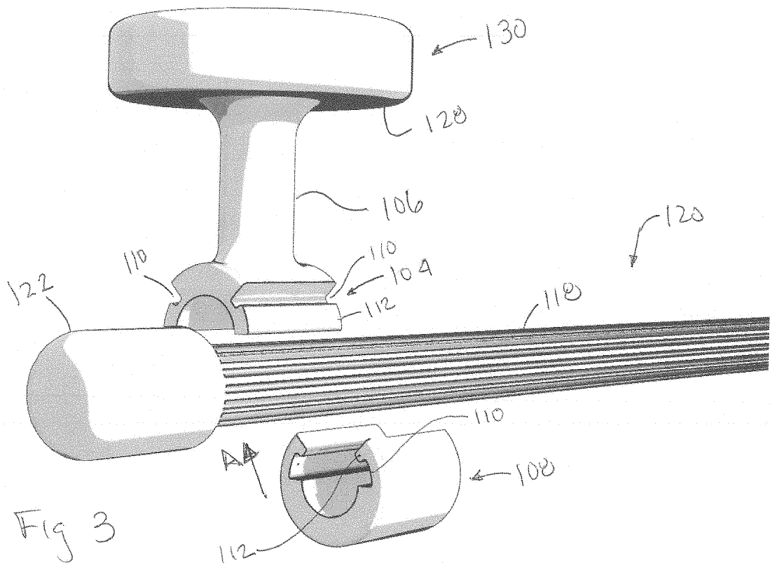

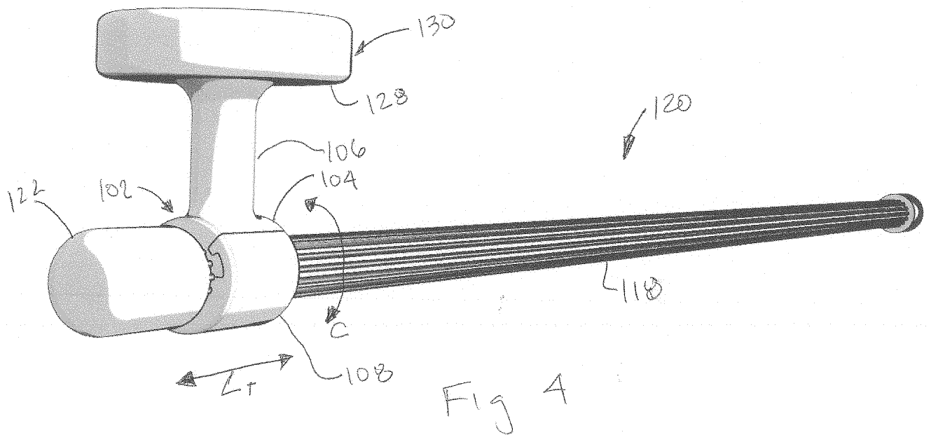

Alternatively, the second portion 108 can be configured to elastically deform such that the projection(s) 112 mate with the concavity(ies) 110. In such alterative, the free ends of the second portion 108, when pushed towards the free ends of the first portion 104 (see Arrow A in FIG. 3) plastically deform radially outward and then return when the projection(s) 112 align with the concavity(ies) 110. Such a fit may be known in the art as a “snap” fit. When the first and second portions are in the attached state as shown in FIG. 1, they define a through hole 114, through which the elongated portion 118 of the reusable twist tie 120 is disposed, as shown in FIG. 4. Such through hole 114 may have an inner diameter slightly smaller than the outer diameter of the elongated portion 118 of the reusable twist tie 120 so as to be secured thereon such that movement in a longitudinal direction L_{T} or circumferential direction C of the elongated portion 118 of the reusable twist tie 120 is not permitted.

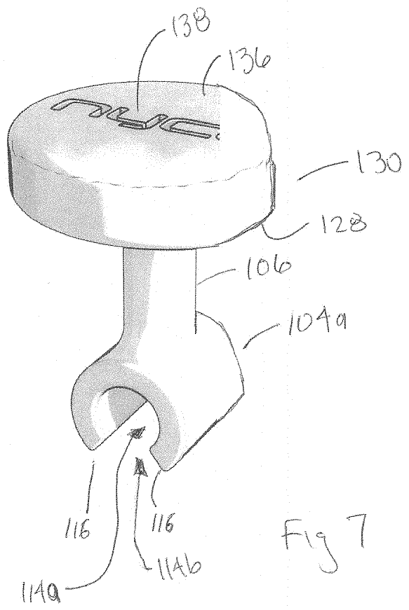

In another configuration of the first end shown in FIG. 7, a first portion 104a is integrally formed with a post 106 where the first end 104a has first and second free ends 116 defining a c-shape in cross section having a through hole 114a which is open on one side 114b. In such configuration, the first portion 104a is formed of a material and is configured to elastically deform to fit over the elongated portion of the reusable twist tie such that the first and second free ends 116 of the first portion 104a, when pushed towards the elongated portion of the reusable twist tie to plastically deform radially outward and then return when the first and second free ends 116 pass over outer diameter of the elongated portion of the reusable twist tie. Such through hole 114a may have an inner diameter slightly smaller than the outer diameter of the elongated portion 118 of the reusable twist tie 120 so as to be secured thereon such that movement in a longitudinal direction L_{T} or circumferential direction C of the elongated portion 118 of the reusable twist tie 120 is not permitted.

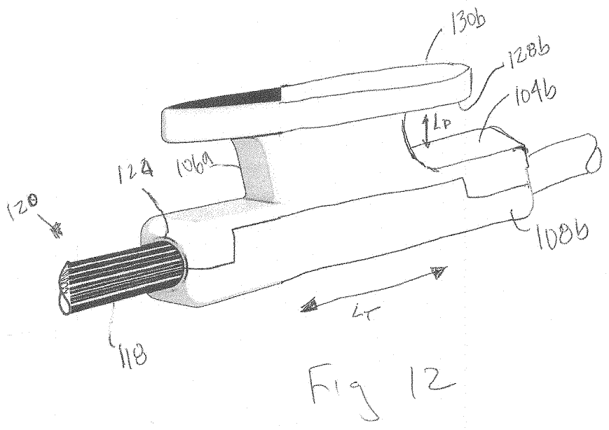

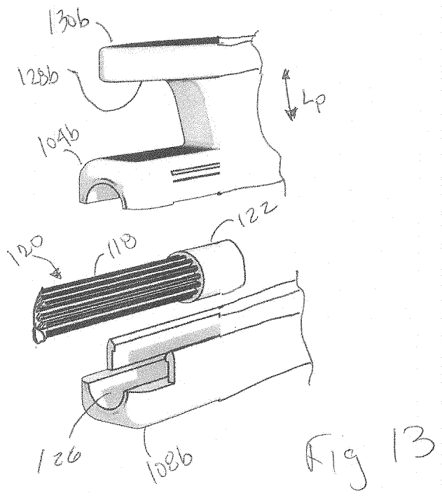

In yet another configuration of the first end, as shown in FIGS. 12 and 13, a first portion 104b and a second portion 108b can have what is known in the art as a clamshell configuration which sandwiches the elongated portion 118 of the reusable twist tie 120 therebetween. In such configuration, the first and second portions 104b, 108b (first and second clamshells) can capture the elongated portion 118 of the reusable twist tie 120 along an entire longitudinal length L_{T} of the first and second portions 104b, 108b or only a portion of the elongated portion 118 of the reusable twist tie 120, which may include an end cap 122. The first and second portions 104b, 108b, when mated, define a through hole 124 to snugly fit over the outer diameter of the elongated portion 118 or may define a blind hole 126 to snugly fit over an end of the elongated portion 118, which may include a larger portion of the blind hole 126 to accommodate the end cap 122. Such first and second portions 104b, 108b can have projections and mating concavities, as is known in the art, for releasably connecting the same together. as with the configurations discussed above, such through hole 124 or blind hole 126 may have an inner diameter slightly smaller than the outer diameter of the elongated portion 118 of the reusable twist tie 120 so as to be secured thereon such that movement in a longitudinal direction L_{T} or circumferential direction C of the elongated portion 18 of the reusable twist tie 120 is not permitted.

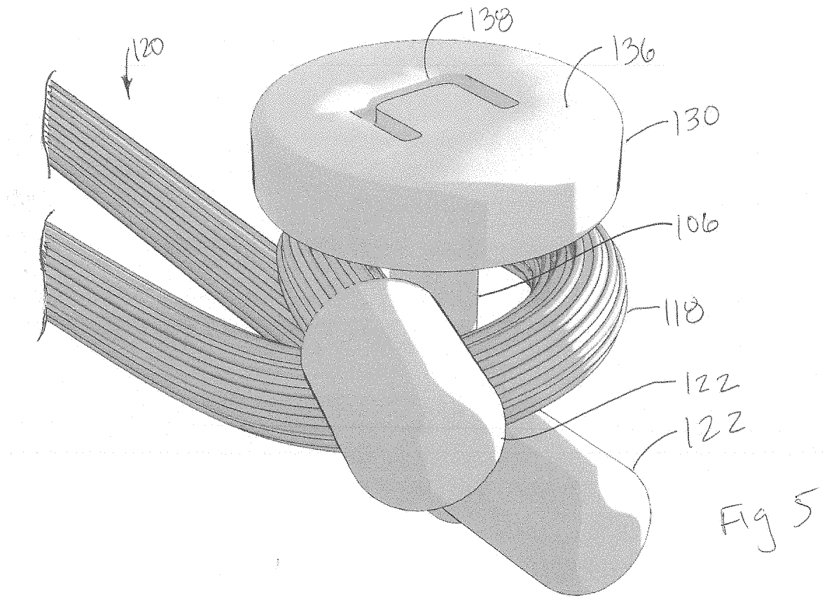

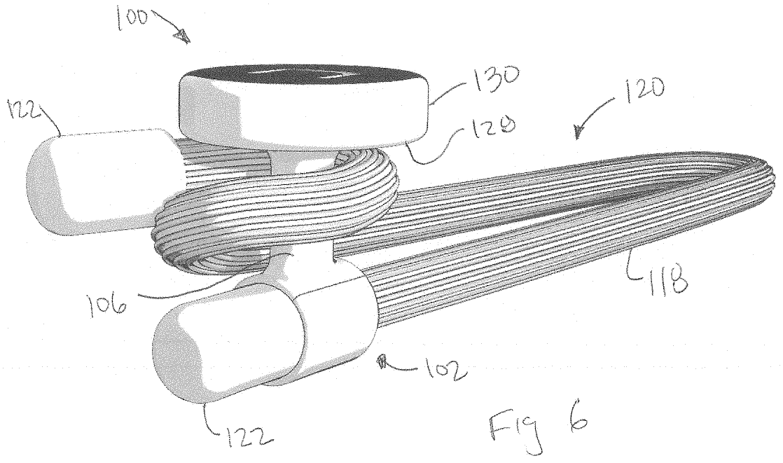

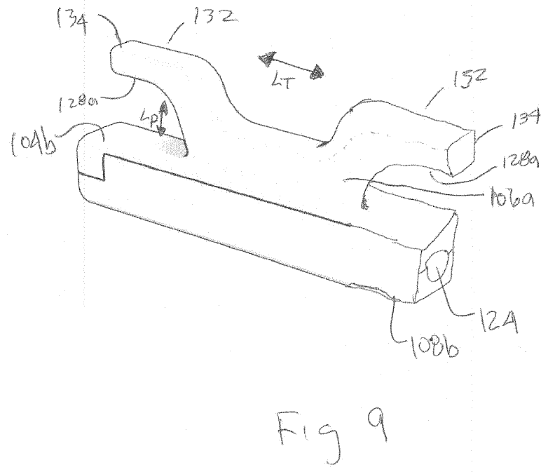

Referring back to FIGS. 1-6, the tie post 100 further includes the post 106 extending in a longitudinal direction L_{P} from the first end 104 to a surface 128 for preventing an wrapped elongated portion 118 of the reusable twist tie 120 from moving in the longitudinal direction L_{P} off of the post 106, as is shown in FIGS. 5 and 6. The post is configured for wrapping the elongated portion 118 of the reusable twist tie 120 around the post 106. As shown in FIG. 1, the post 106 can be circular in cross section. A length of the post 106 can be at least twice an outer diameter of the elongated portion 118 of the reusable twist tie 120 so as to accommodate at least 2 wraps of the elongated portion 118 around the post 106. In an alternative configuration, as shown in FIGS. 9 and 12, the post 106a can be elongated in the L_{T} direction. Furthermore, although the post 106, 106a are shown to be singular, more than one post can be used to extend between the first end 104, 104a, 104b and the surface 128 that that prevents the wrapped elongated portion 118 of the reusable twist tie 120 from moving in the longitudinal direction L_{P} off of the post, in which case an equal number of separate surfaces 128 may be provided corresponding to each post.

Referring back to FIG. 1, a second end 130 of the tie post 100 has the surface 128 for preventing the wrapped elongated portion 118 of the reusable twist tie 120 from moving in the longitudinal direction L_{P} off of the post 106. In the configuration shown in FIG. 1, the second end 130 is a cylindrical disk and the surface 128 is a lower surface of a cylindrical disk that attaches to the post 106. An outer diameter of the second end 130 can be any size that prevents the wrapped elongated portion 118 of the reusable twist tie 120 from moving in the longitudinal direction L_{P} off of the post 106. For example, the outer diameter of the second end 130, when configured as a cylindrical disk can be such that an amount of the surface 128 that overhangs from the post 106 is about the same as an outer diameter of the elongated portion 118 of the reusable twist tie 120. In other words, half of a difference between an outer diameter of the post 106 and an outer diameter of the cylindrical disk is equal to or greater than an outer diameter of the elongated portion 118 of the reusable twist tie 120.

Although the first end, 102, post 106 and second end 130 are shown integrally formed in a single piece, such features may be formed in two or more separate pieces and assembled together, such as with adhesive or other fasteners.

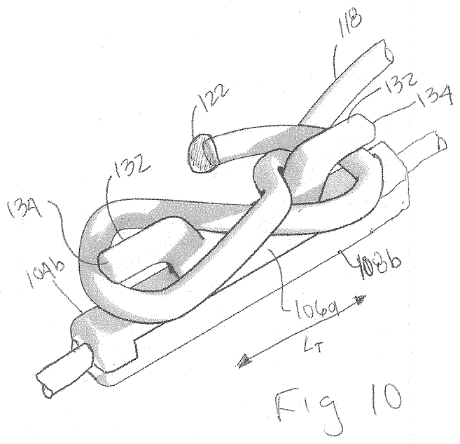

As shown in FIG. 9, the surface 128a can be elongated in the L_{T} direction where the second end comprises first and second cleats 132 extending from the post 106a, a free end 134 of the first and second cleats 132 extending in opposing directions in the L_{T} direction. A configuration of such cleats is well known in the art, particularly in the boating art in which the elongated portion 118 of the reusable twist tie 120 can be wrapped around the post 106a and cleats 132 in a manner known in the boating arts, such as that shown in FIG. 10. Although the configuration of the tie post in FIGS. 9 and 10 is shown with the clamshell configuration at the first end (discussed above with regard to FIGS. 12 and 13), any of the above first end configurations can also be utilized.

Furthermore, the reusable twist tie 120 can be used in the configuration of FIG. 9 to secure the tie post having such first and second cleats 132 to another object, such as a boat railing. In such configuration, the tie post having the cleats 132 can be used with a rope to tie down the boat, thereby adding an additional boat cleat to the boat. Additionally, the tie post in the configuration of FIG. 9 can be alternatively used with a rope disposed through the hole 124 where the rope can be used to secure the tie post to another object or alternatively, the rope can be used to secure to the first and second cleats 132.

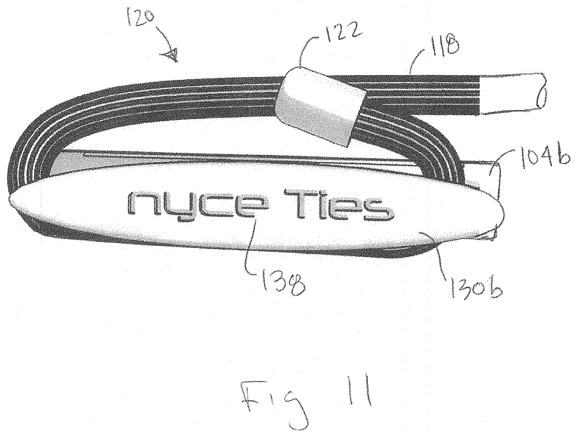

As shown in FIG. 12, the surface 128b can be elongated in the L_{T} direction such that the second end 130b has an elongated shape in the L_{T} direction, such as an elongated or oval shaped disk. The tie post as shown in FIG. 12 can accommodate the elongated portion 118 of the reusable twist tie 120 as shown in FIG. 11. Although the configuration of the tie post in FIGS. 12 and 13 is shown with the clamshell configuration at the first end, any of the above first end configurations can also be utilized.

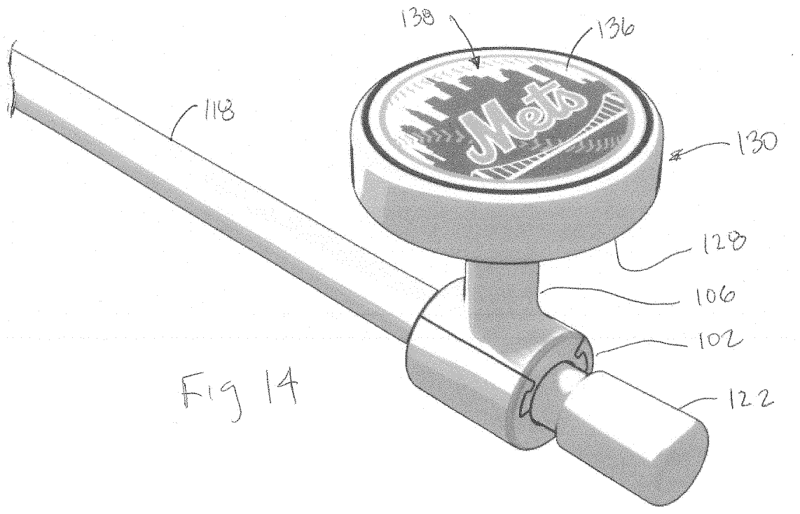

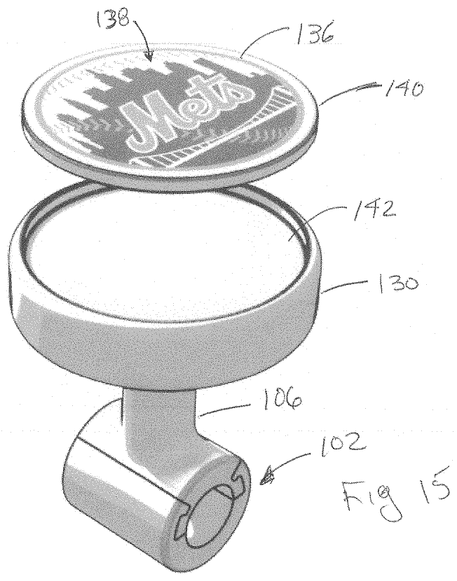

As shown in FIG. 1, the second end 130 can include an other surface 136, such as the top surface of the cylindrical disk having an indicia 138 provided thereon. Such indicia can be writing, a company logo, an illustration, an image etc. As shown in FIG. 14, the indicia 138 can be a logo, such as a sports team printed and/or otherwise disposed (such as engraving) on the other surface 136. In addition, the indicia can be a seasonal image, such as a snowflake for winter, a Christmas tree for Christmas holidays, a school or university logo/name or a company name. As shown in FIG. 15, the other surface 136 having the indicia 138 can be part of an insert 140, which is disposed on the second end 130 or fits within a corresponding concavity 142 on the second end 130. In the configuration shown in FIG. 15, the insert 140 is a thin cylindrical disk and the corresponding concavity 142 is also cylindrical. The insert 140 can fasten to the second end 130 by any means known in the art, such as a press fit, snap-fit, magnetic attraction etc., such that the fit is releasable. In which case, inserts 140 having different indicia can be interchanged with one another. In addition, the insert 140 can be fixed to the second end 130, such as by adhesive.

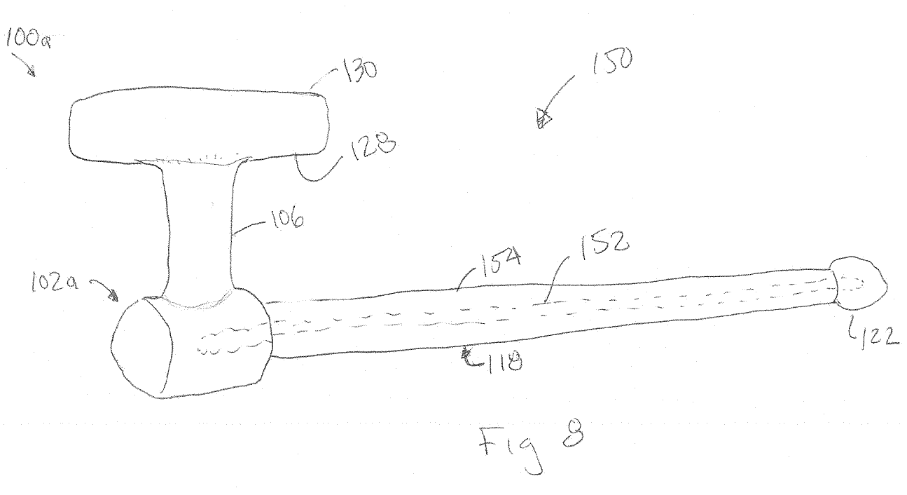

Referring now to FIG. 8, there is shown an embodiment of a reusable twist tie, generally referred to by reference number 150. The reusable twist tie 150 having an elongated core formed of a malleable material 152 and an outer cover 154 for covering the core 152. As discussed above, the malleable material can be a metallic wire and the outer cover can be formed of an elastomer, such as rubber. First and second end caps are disposed at corresponding ends of the outer cover 154 and formed of a material having a greater hardness than the outer cover, such as a hard plastic.

However, at least one of the first and second end caps comprises a tie post 100a where a first end 102a of the tie post 100a is integrally formed with the first and/or second end caps. In the configuration shown in FIG. 8, the reusable twist tie 150 includes one end cap 122 having a conventional configuration and another end cap being the first end 102a and corresponding tie post 100a. However, each end cap may be configured as a tie post either having a same configuration or different configurations.

Although the tie post 100a is shown in FIG. 8 as having a configuration similar to that of FIG. 1 (with the exception of the first end 102a), such tie post can have any of the configurations discussed above with a corresponding first end integrally formed with the end cap.

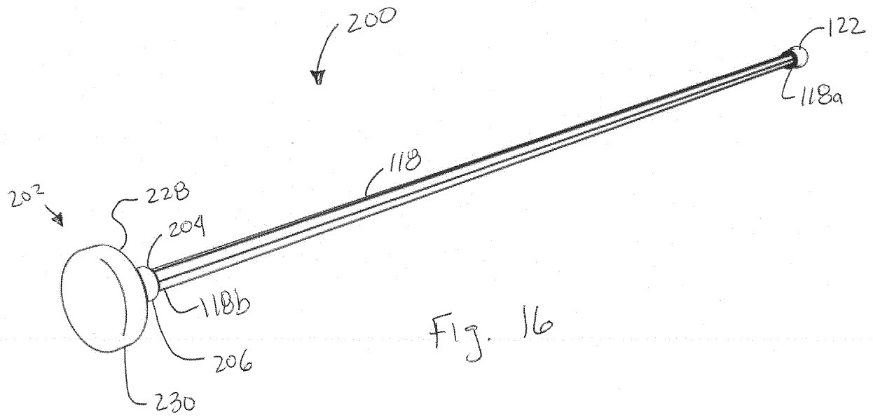

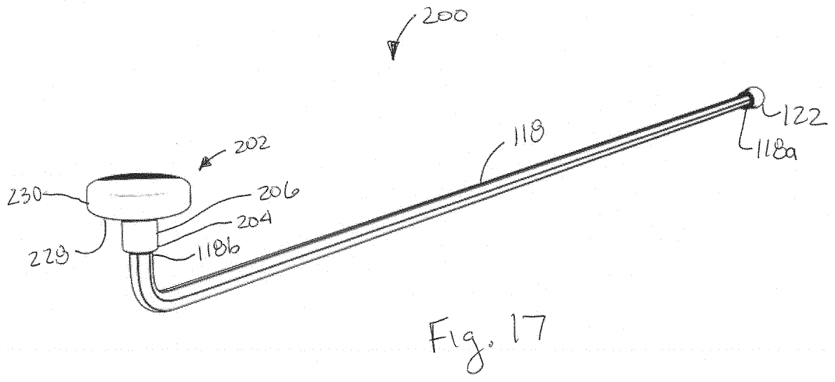

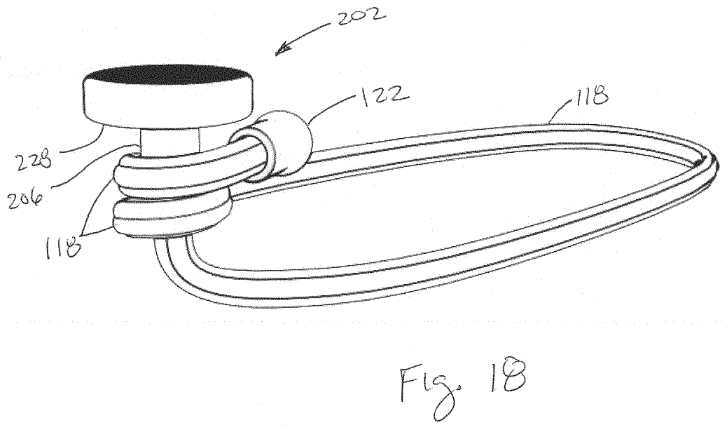

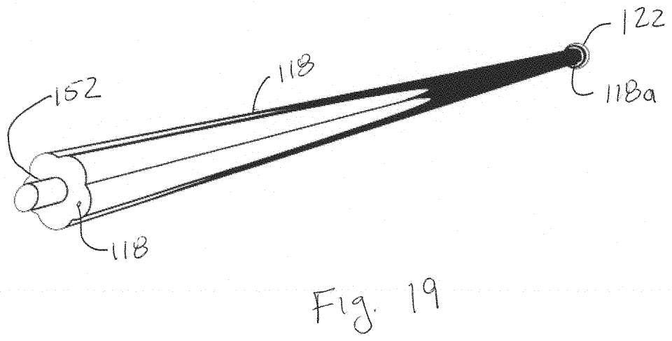

Referring now to FIGS. 16-19, there is shown another embodiment of twist tie, generally referred to by reference numeral 200, in which similar features are designed with similar reference numbers from FIGS. 1-15. As known in the art, the reusable twist tie 200 includes the elongated portion 118 having an elongated core formed of a malleable material (see FIG. 19), such as a metallic wire and an outer cover for covering the core, the outer cover is generally formed of an elastomer, such as rubber. FIG. 17 shows the elongated core 118 and tie post 202 each extending in the longitudinal direction of the elongated core, while FIG. 18 shows the tie post 202 being bent to be offset from such longitudinal direction. The reusable twist tie 200 also has an end cap 122 disposed at a first end 118a of the outer cover 154. The end cap 122 being generally formed of a material having a greater hardness than the outer cover 154, such as a hard plastic.

A post 206 is provided at a second end of the outer cover and can be formed, such as by injection molding from plastic or other resilient materials. A first end 204 of the post 206 is fixed to a second end 118b of the outer cover 154. The malleable material 152 and outer cover 154 extend into both the end cap 122 and the tie post 206 and are fixed thereon by any means known in the art, such as by adhesive, press-fit and crimping.

The post 206, similarly to that discussed above, extends in a longitudinal direction from the post 206 to a surface 228 at a second end 230 of the tie post 202 for preventing a wrapped elongated portion 118 of the reusable twist tie 200 from moving in the longitudinal direction off of the post 206, as is shown in FIG. 18. The post 206 is configured for wrapping the elongated portion 118 of the reusable twist tie 200 around the post 206. A length of the post 206 from the first end 204 to the surface 228 can be at least twice an outer diameter of the elongated portion 118 of the reusable twist tie 200 so as to accommodate at least 2 wraps of the elongated portion 118 around the post 206.

As shown in FIGS. 16-18, the post 206 and second end 230 can be circular in cross section or have any of the configurations discussed above, including having a fixed indicia on a top surface of the second end, as shown in FIG. 7 or a removable indicia as shown in FIGS. 14 and 15. The tie post 202 can also be elongated such as shown in FIGS. 9-13.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A reusable twist tie comprising:
an elongated core formed of a malleable material;
an outer cover for covering the core, the outer cover being formed of an elastomer;
an end cap formed of a material having a greater hardness than the outer cover, the end cap being fixed at a first end of the outer cover; and
a tie post comprising:
a first end fixed to a second end of the outer cover;
a post extending in a longitudinal direction from the first end configured for wrapping the outer cover around the post; and
a second end having a surface for preventing the wrapped outer cover from moving in the longitudinal direction off of the post.

2. The reusable twist tie of claim 1, wherein the post is circular in cross section.

3. The reusable twist tie of claim 2, wherein a length of the post in the longitudinal direction is at least twice an outer diameter of the outer cover.

4. The reusable twist tie of claim 1, wherein the surface of the second end is a lower surface of a cylindrical disk at the second end.

5. The reusable twist tie of claim 4, wherein half a difference between an outer diameter of the post and an outer diameter of the cylindrical disk is equal to or greater than an outer diameter of the elongated portion of the reusable twist tie.

6. The reusable twist tie of claim 1, wherein the second end includes an other surface having an indicia provided thereon.

7. The reusable twist tie of claim 6, wherein the other surface is removable from the second end.
